(19) United States
(12) Patent Application Publication
(10) Pub. No.: US 2025/0065354 A1
(43) Pub. Date: Feb. 27, 2025

(54) SYSTEMS AND METHODS FOR CLEANING GUN-STYLE APPLICATORS

(71) Applicant: CyCan Industries, Inc., Woodstock, GA (US)

(72) Inventor: James R. Spinks, McDonough, GA (US)

(21) Appl. No.: 18/454,529

(22) Filed: Aug. 23, 2023

(51) Int. Cl. B05B 15/55; B05B 11/00

(52) U.S. Cl. CPC B05B 15/557; B05B 11/0037

(57) ABSTRACT

Systems and methods for cleaning gun-style applicators are provided that reduce the costs associated with cleaning applicators as well as the cost and burden associated with disposing of containers of cleaning material when they are empty. An adapter of the system has a first end that couples with an output port of a canister of aerosolized cleaning material and a second end that couples with a first end of a hose having a second end that couples with an input port of the applicator. Actuation of a trigger of the applicator causes the aerosolized cleaning material to flow through a bore of the adapter, through the hose, through an internal portion of the gun-style applicator and out of a nozzle of the gun-style applicator.

### BACKGROUND

Gun-style applicators, or spray guns, are used in a variety of applications to apply various types of materials to surfaces. Spray guns are used to apply materials such as, for example, adhesives, lubricants, penetrants, paints and cleaners to various types of surfaces. The materials to be applied are typically in the form of an aerosol or liquid contained in a pressurized container that connects to the spray gun via a hose. Once connected, the user pulls the trigger of the spray gun to cause the material to be sprayed onto the targeted surface.

When spray guns are used, residue from the applied material remains on interior surfaces of the spray gun and can detrimentally impact performance of the gun if the residue is not removed. One known approach for cleaning spray guns is to connect the spray gun via the hose to a valve of a pressurized cylinder of cleaning material. Once connected, the user opens the valve and pulls the trigger of the spray gun to cause the cleaning material to pass through the interior of the gun and out of the nozzle of the gun to flush the residue out of the gun.

The pressurized cylinders of cleaning material that are used for this purpose are typically relatively large in size and weight (e.g., 7 or 22 liter), are relatively expensive to purchase, and are relatively difficult and costly to dispose of when empty.

A need exists for a system and method for cleaning gun-style applicators that overcomes these disadvantages.

### SUMMARY OF THE DISCLOSURE

A system, method, and other examples are disclosed for cleaning gun-style applicators. The system comprises an adapter having a first end, a second end, a body extending from the first end to the second end, and a bore extending through the body from the first end to the second end. The first end is configured to be coupled with an output port of an aerosol canister containing aerosolized cleaning material. The second end of the adapter is configured to couple with a first end of a hose having a second end that couples with an input port of the gun-style applicator. The first end of the adapter comprises a valve configured to engage a valve disposed in the output port of the adapter when the first end of the adapter is coupled with the output port of the aerosol canister. Actuation of a trigger of the gun-style applicator when the valves are engaged and the first and second ends of the hose are coupled to the second end of the adapter and to the output port of the gun-style applicator, respectively, causes the aerosolized cleaning material to flow through the bore of the adapter, through the hose, through an internal portion of the gun-style applicator and out of a nozzle of the gun-style applicator.

The method for cleaning a gun-style applicator comprises:
providing an adapter having a first end, a second end, a body extending from the first end to the second end, and a bore extending through the body from the first end to the second end;
coupling the first end of the adapter with an output port of an aerosol canister containing aerosolized cleaning material, wherein coupling the first end of the adapter with the output port of the aerosol canister causes a valve of the adapter to engage a valve disposed in the output port of the adapter to allow aerosolized cleaning material to flow from the aerosol canister into the bore of the adapter;
coupling the second end of the adapter with a first end of a hose;
coupling a second end of the hose with an input port of the gun-style applicator; and
actuating a trigger of the gun-style applicator causing the aerosolized cleaning material to flow through the bore of the adapter, through the hose, through an internal portion of the gun-style applicator and out of a nozzle of the gun-style applicator.

These and other features and advantages will become apparent from the following description, drawings and claims.

### BRIEF DESCRIPTION OF THE DRAWINGS

In the Figures, like reference numerals refer to like parts throughout the various views unless otherwise indicated.

FIG. 1 illustrates a system in accordance with a representative embodiment being used to clean a gun-style applicator, or spray gun, of the type that is typically used to apply adhesives or paint, for example, to surfaces.

FIGS. 2 and 3 illustrate the adapter shown in FIG. 1 in accordance with a representative embodiment positioned above the output port of the aerosol can shown in FIG. 1 as the adapter is moved toward the can to couple the first end of the adapter with the output port of the can.

FIG. 4 illustrates a side cross-sectional view of the adapter shown in FIGS. 1 and 2 in accordance with a representative embodiment.

FIG. 5A illustrates a side cross-sectional view of the basket of the adapter shown in FIGS. 1-5 with the outer threaded surface of a portion of the adapter threadingly engaged with the inner threaded surface of the basket.

FIG. 5B illustrates an enlarged view of the encircled area 115 shown in FIG. 5A.

FIG. 6 illustrates a system in accordance with another representative embodiment being used to clean the gun-style applicator shown in FIG. 1.

FIG. 7 illustrates a front cross-sectional view of the adapter shown in FIG. 6 partially disassembled.

FIG. 8 illustrates a side cross-sectional view of the adapter shown in FIG. 7 fully assembled.

### DETAILED DESCRIPTION

The present disclosure discloses a system and method for cleaning gun-style applicators that reduce the costs associated with containers of cleaning material and the cost and challenge of disposing of the containers when they are empty. The system comprises an adapter that is configured to couple an output port of an aerosol canister of aerosolized cleaning material that typically holds about 12 ounces to 24 ounces of cleaning material to a hose that connects on one end to the adapter and on the opposite the end to input port of the gun-style applicator. Actuation of a trigger of the applicator causes the aerosolized cleaning material to flow through a bore of the adapter, through the hose, through an internal portion of the gun-style applicator and out of a nozzle of the gun-style applicator.

The hose can be identical to the hose that is currently used to connect gun-style applicators to the cylinders of cleaning material. The aerosol canister is relatively small in size, can be hand-held and typically contains between about 12 ounces and 24 ounces of aerosolized cleaning material. Such canisters much less expensive to purchase, much easier to use, and much easier and much less expensive to dispose of when empty than the larger cylinders of cleaning material that are currently used to clean gun-style applicators.

In the following detailed description, for purposes of explanation and not limitation, exemplary, or representative, embodiments disclosing specific details are set forth in order to provide a thorough understanding of an embodiment according to the present teachings. The word “exemplary” is used herein to mean “serving as an example, instance, or illustration.” The words “illustrative” or “representative” may be used herein synonymously with “exemplary.” Any aspect described herein as “exemplary” is not necessarily to be construed as preferred or advantageous over other aspects. However, it will be apparent to one having ordinary skill in the art and having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” another element, it can be directly connected or coupled, or intervening elements may be present.

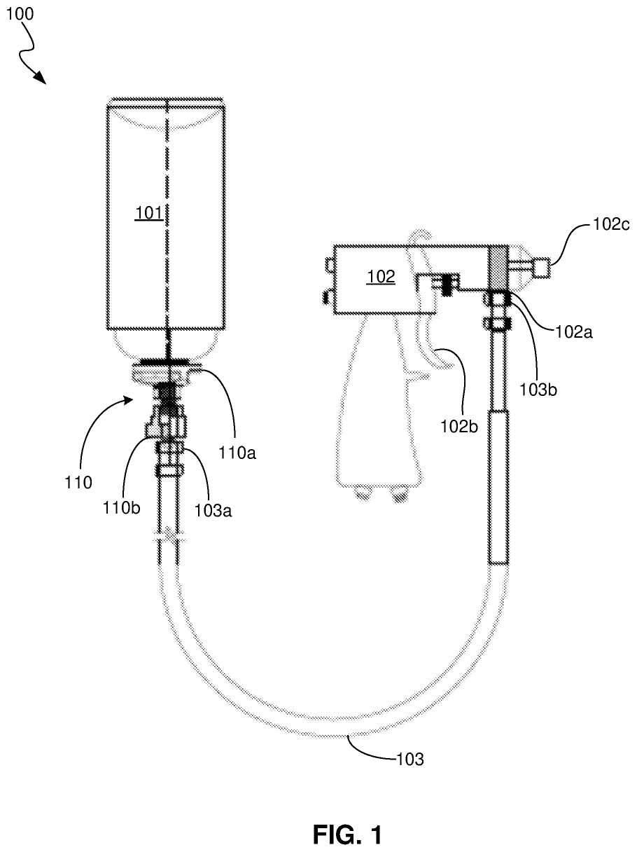

FIG. 1 illustrates a system 100 in accordance with a representative embodiment being used to clean a gun-style applicator 102, or spray gun, of the type that is typically used to apply adhesives or paint, for example, to surfaces. The system 100 comprises an adapter 110 having a first end 110a that couples with an output port of an aerosol canister (can) 101 and a second end 110b that couples with a first end 103a of a hose 103, the opposite end 103b of which couples with an input port 102a of the applicator 102. In accordance with a representative embodiment, the first end 110a of the adapter 110 threadingly engages the aerosol canister 101. Threading engagement of the first end 110a of the adapter 110 with the aerosol can 101 causes a male valve (not shown) of adapter 110 to be received in a female valve (not shown) of the aerosol can 101, or visa versa, to allow aerosolized cleaning material contained in the can 101 to flow into the adapter 110. which then couples the aerosolized cleaning material into the first end 103a of the hose 103. When a user actuates a trigger 102b of the applicator 102, the aerosolized cleaning material flowing in the hose 103 flows through the interior of the applicator 102 and out of a nozzle 102c of the applicator 102, thereby cleaning the interior parts of the applicator 102.

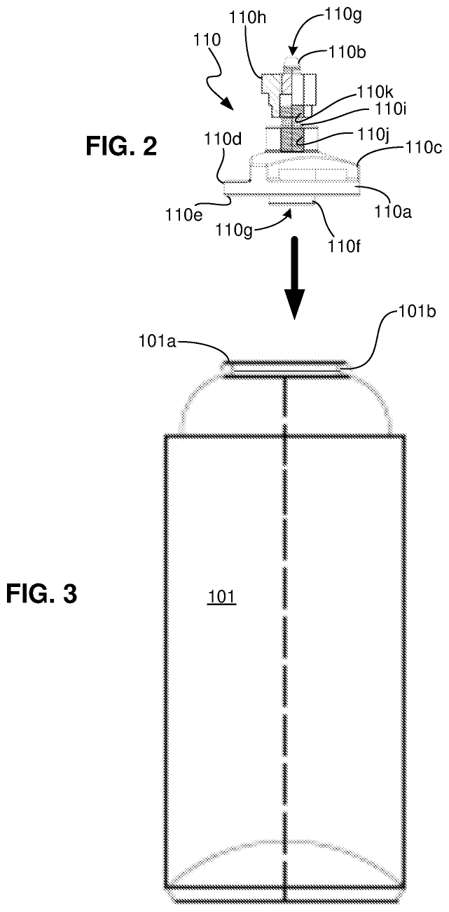

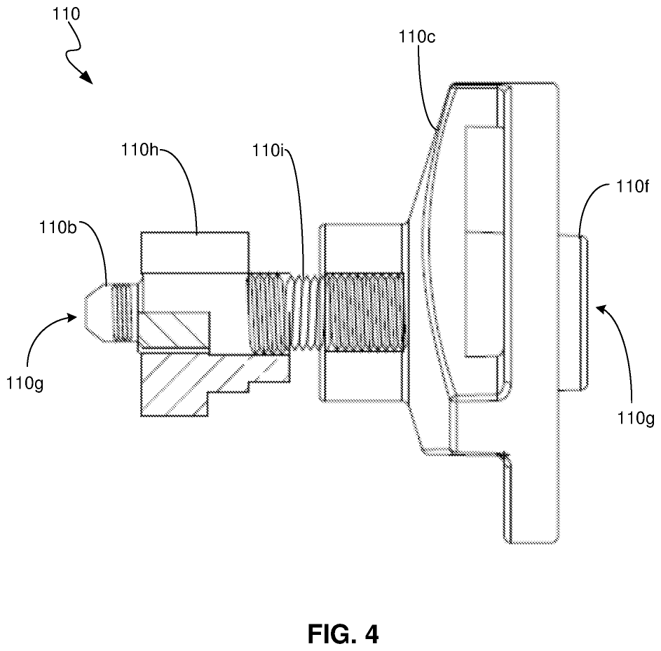

FIGS. 2 and 3 illustrate the adapter 110 positioned above the output port of the aerosol can 101 as the adapter 110 is moved toward the can 101 to couple the first end 110a of the adapter 110 with the output port of the can 101. FIG. 4 illustrates a side cross-sectional view of the adapter 110. A variety of coupling arrangements can be used to couple the output port of the can 101 with the first end 110a of the adapter 110. In accordance with a representative embodiment, the first end 110a of the adapter 110 comprises a “basket” 110c having an outer ring 110d that has a threaded inner surface 110c. The diameter of the outer ring 110d and the inner threaded surface 110e are sized and shaped to be complementary in size and shape to a lip 101a of the can 101 that has an outer threaded surface 101b to allow the inner threaded surface 110e to threadingly engage the outer threaded surface 101b. When this threading engagement occurs, a valve 110f of the adapter 110 engages a valve (not shown) inside of the output port of the can 101 to cause the aerosol cleaning material contained in the can 101 to flow into the adapter 110. The second end 110b of the adapter 110 can have an outer threaded surface that is complementary in shape and size to an inner threaded surface of the first end 103a of the hose 103, which can be a standard hose of the type commonly used with spray guns, e.g., a rubber hose with inner casing.

The adapter 110 can have a variety of shapes and form factors. In accordance with this representative embodiment, the adapter 110 has a central axis that is aligned with a central longitudinal axis of the can 101. The adapter 110 has a central, generally hollow bore 110g that extends through the adapter 110 from the first end 110a of the adapter 110 to the second end 110b of the adapter 110. The adapter 110 can be a single piece part or a multi-piece part. In accordance with this representative embodiment, the adapter 110 is a multi-piece part comprising the basket 110c, a portion 110h that comprises the second end 110b of the adapter 110 and a portion 110i that interconnects the basket 110c with the portion 110h.

In accordance with this representative embodiment, the portion 110i is a fitting having a threaded outer surface that threadingly engages complementary female-threaded inner surfaces 110j and 110k of the basket 110c and of the portion 110h, respectively. However, other mechanical coupling arrangements can be used for this purpose. For example, a portion of the central bore of the portion 110i could be welded or attached with adhesive to a portion of the central bore of the basket 110c, thereby obviating the need for the portion 110i. As another example, a portion of the central bore of the basket 110c could extend outwardly from the basket 110c toward portion 110h and have male threads to mate with female threads on the inner surface of portion 110h to allow the basket 110c to threadingly engage the portion 110h, thereby obviating the need for portion 110i. Also, as indicated above, the adapter 110 can be a single piece part. Making the adapter 110 of multiple parts can reduce costs compared to making it as a single piece part, or an integrally-formed part.

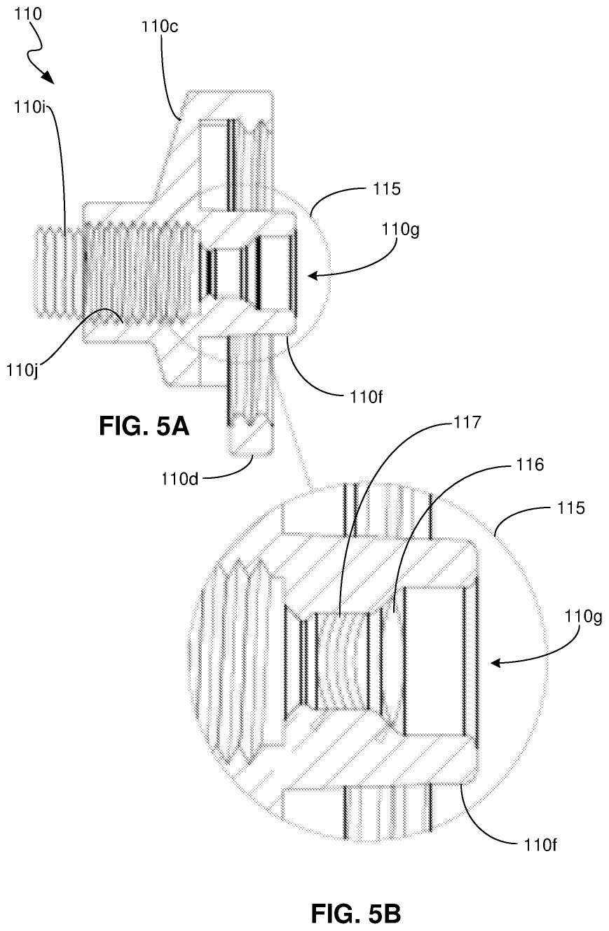

FIG. 5A illustrates a side cross-sectional view of the basket 110c of the adapter 110 with the outer threaded surface of portion 110i threadingly engaged with the inner threaded surface of the basket 110c. The portion 110h of the adapter 110 is not shown in FIG. 5A. FIG. 5B illustrates an enlarged view of the encircled area 115 in FIG. 5A. As can be seen in FIG. 5B, the valve 110f comprises a check valve comprising a ball 116 and a compression spring 117. When the valve 110f of the basket 110c engages the valve (not shown) located inside of the output port of the aerosol can 101, the ball 116 is pressed against the spring 117 causing the spring 117 to compress. Movement of the ball 116 in this manner unblocks the bore 110g to allow aerosol cleaning material to flow from the can 101 through the bore 110g of the adapter 110. When the valve 110f disengages the valve (not shown) located inside of the output port of the can 101, the spring 117 decompresses causing the ball 116 to block the bore 110g to prevent aerosol cleaning material from flowing from the bore 110g of the adapter 110.

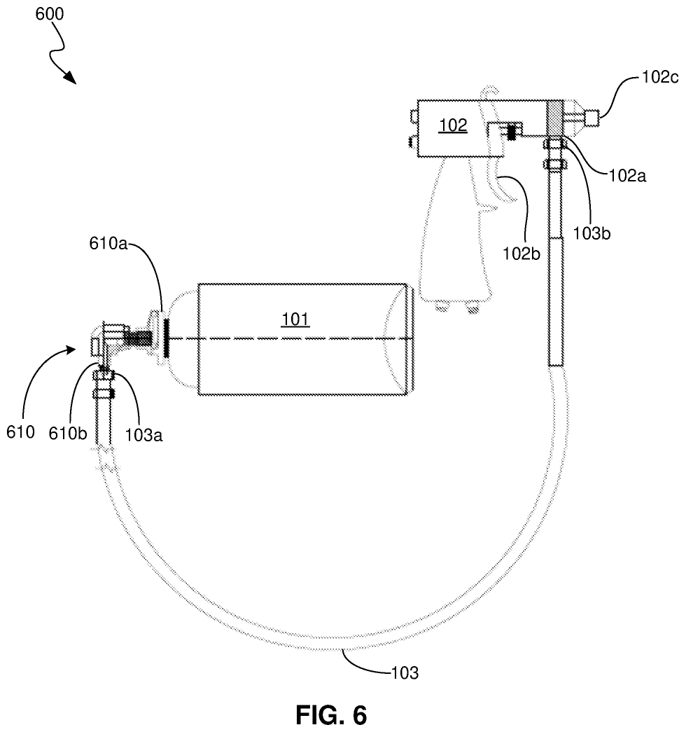

FIG. 6 illustrates a system 600 in accordance with another representative embodiment being used to clean the gun-style applicator 102 shown in FIG. 1. The system 600 comprises an adapter 610 having a first end 610a that couples with an output port of the aerosol can 101 and a second end 610b that couples with the first end 103a of the hose 103, the opposite end 103b of which couples with the input port 102a of the applicator 102. In accordance with this representative embodiment, the adapter 610 has a hollow bore that has first and second central axes that are perpendicular to one another such that the adapter 610 has a 90 degree bent-elbow shape, but the angle of bend could be any non-zero-degree angle.

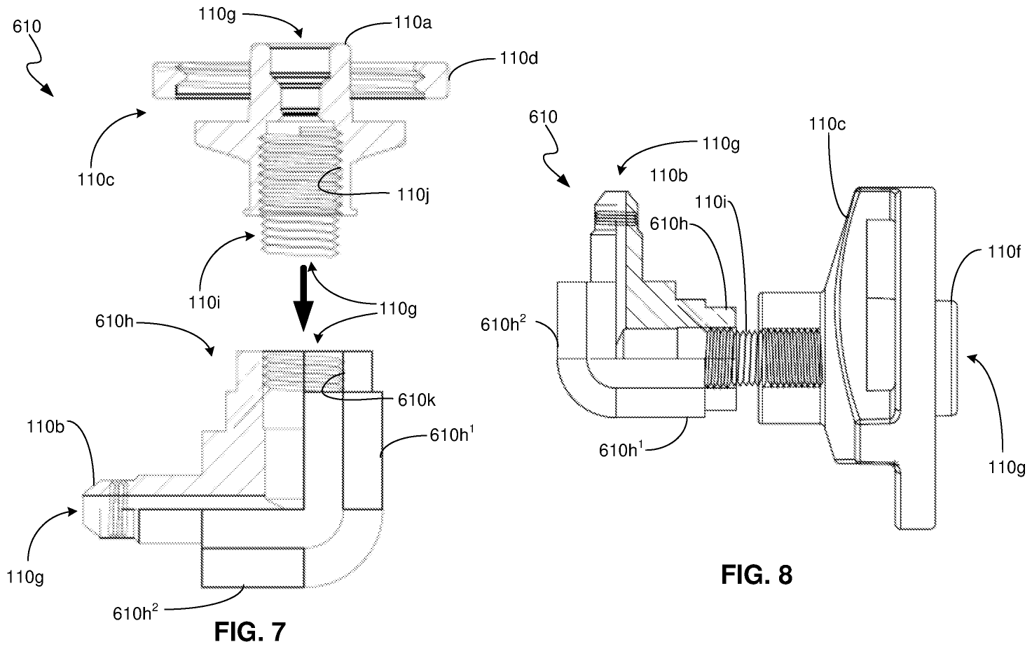

FIG. 7 illustrates a front cross-sectional view of the adapter 610 partially disassembled showing the basket 110c and portion 110i of the adapter 610 interconnected and being moved toward a portion 610h of the adapter 610 to threadingly engage the portion 110i with portion 610h. FIG. 8 illustrates a side cross-sectional view of the adapter 610 shown in FIG. 7 fully assembled.

In accordance with this representative embodiment, the basket 110c and the portion 110i of the adapter 610 are identical to the basket 110c and the portion 110i of the adapter 110, respectively, shown in FIGS. 1-5B, but the portion 610h of the adapter 610 has a shape that is different from the shape of the portion 110h of the adapter 110 shown in FIGS. 1-5B. In particular, the portion 610h of the adapter 610 has first and second portions 610h¹ and 610h², respectively, having respective central axes that are perpendicular to one another to provide the adapter 610 with the aforementioned 90 degree bent-elbow shape.

The threads on the outer surface of portion 110i threadingly engage threads 610k on the inner surface of the bore of the portion 610h of the adapter 610 in the same manner described above in which threads on the outer surface of portion 110i threadingly engage threads 110k on the inner surface of the bore of the portion 110h of adapter 110.

In accordance with the representative embodiment shown in FIG. 8, as with the embodiment represented by FIGS. 1-5B, the first end 110a of the adapter 610 threadingly engages the aerosol canister 101 causing a female valve (not shown) of adapter 610 to be received by a male valve (not shown) of the aerosol can 101, or visa versa, to allow aerosolized cleaning material contained in the can 101 to flow into the adapter 610, which then couples the aerosolized cleaning material into the first end 103a of the hose 103.

With reference again to FIG. 6, the adapter 610 operates in the same manner as the adapter 110, i.e., when a user actuates a trigger 102b of the applicator 102, the aerosolized cleaning material flowing in the hose 103 flows through the interior of the applicator 102 and out of a nozzle 102c of the applicator 102, thereby cleaning the interior parts of the applicator 102.

As indicated above, the adapter can have a variety of shapes and form factors. In accordance with this representative embodiment, the basket 110c, portion 110i of the adapter 610 and first portion 610h¹ of the adapter 610 have central axes that are coaxial with one another and that are aligned with the central longitudinal axis of the can 101 when the adapter 610 and the can 110 are interconnected. However, the second portion 610h² of portion 610h of the adapter 610 has a central axis that is perpendicular to the axes of basket 110c, portion 110i and first portion 610h¹ of portion 610h. In all other respects, the adapters 110 and 610 can be identical and can operate in identical manners. As with the adapter 110, adapter 610 can be a single piece part or a multi-piece part.

Alternative embodiments will become apparent to one of ordinary skill in the art to which the invention pertains in view of the present disclosure. Therefore, although selected aspects have been illustrated and described in detail, it will be understood that various substitutions and alterations may be made therein.

What is claimed is:

1. A system for cleaning a gun-style applicator comprising:
an adapter having a first end, a second end, a body extending from the first end to the second end, and a bore extending through the body from the first end to the second end, the first end being configured to be coupled with an output port of an aerosol canister containing aerosolized cleaning material, the second end being configured to couple with a first end of a hose having a second end that is configured to be coupled with an input port of the gun-style applicator, the first end of the adapter comprising a valve configured to engage a valve disposed in the output port of the adapter when the first end of the adapter is coupled with the output port of the aerosol canister; and
wherein actuation of a trigger of the gun-style applicator when the valves are engaged and the first and second ends of the hose are coupled to the second end of the adapter and to the output port of the gun-style applicator, respectively, causes the aerosolized cleaning material to flow through the bore of the adapter, through the hose, through an internal portion of the gun-style applicator and out of a nozzle of the gun-style applicator.

2. The system of claim 1, wherein the adapter comprises at least first and second portions, the first portion comprising the first end of the adapter and a first portion of the body through which a first portion of the bore extends, the second portion comprising the second end of the adapter and a second portion of the body through which a second portion of the bore extends, the first and second portions of the adapter having second and first ends, respectively, that are coupled together.

3. The system of claim 2, wherein the first and second portions of the adapter have first and second central axes that are coaxial with one another.

4. The system of claim 2, and wherein the first and second portions of the adapter have first and second central axes that are perpendicular to one another.

5. The system of claim 1, wherein the adapter comprises at least first, second and third portions, the first portion comprising the first end of the adapter and a first portion of the body through which a first portion of the bore extends, the second portion comprising the second end of the adapter and a second portion of the body through which a second portion of the bore extends, the third portion comprising a third portion of the body through which a third portion of the bore extends, the first and second portions of the adapter having second and first ends, respectively, that are coupled together via the third portion of the adapter.

6. The system of claim 5, wherein the first, second and third portions of the adapter have first, second and third central axes that are coaxial with one another.

7. The system of claim 6, wherein the third portion of the adapter has first and second ends that threadingly engage the second and first ends, respectively, of the first and second portions, respectively, of the adapter, and wherein the first end of the adapter is configured to threadingly engage the output port of the aerosol canister.

8. The system of claim 5, wherein the first and third portions of the adapter have first and third central axes that are coaxial, respectively, and wherein the second portion of the adapter has second and fourth central axes that are at a non-zero-degree angle to one another.

9. The system of claim 8, wherein the non-zero-degree angle is ninety degrees.

10. The system of claim 8, wherein the third portion has first and second ends that threadingly engage the second and first ends, respectively, of the first and second portions, respectively, of the adapter.

11. The system of claim 10, wherein the first end of the adapter is configured to threadingly engage the output port of the aerosol canister.

12. The system of claim 11, wherein the second end of the adapter is configured to threadingly engage the first end of the hose.

13. The system of claim 1, wherein the adapter is an integrally-formed, single-piece part comprising at least first and second portions, the first portion comprising the first end of the adapter and a first portion of the body through which a first portion of the bore extends, the second portion comprising the second end of the adapter and a second portion of the body through which a second portion of the bore extends, the first and second portions of the adapter having second and first ends, respectively, that join one another.

14. The system of claim 13, and wherein the first and second portions of the adapter have first and second central axes that are coaxial with one another.

15. The system of claim 13, and wherein the first and second portions of the adapter have first and second central axes that are at a non-zero-degree angle to one another.

16. The system of claim 15, wherein the non-zero-degree angle is ninety degrees.

17. The system of claim 13, wherein the first end of the adapter is configured to threadingly engage the output port of the aerosol canister.

18. The system of claim 17, wherein the second end of the adapter is configured to threadingly engage the first end of the hose.

19. A method for cleaning a gun-style applicator comprising:
providing an adapter having a first end, a second end, a body extending from the first end to the second end, and a bore extending through the body from the first end to the second end;
coupling the first end of the adapter with an output port of an aerosol canister containing aerosolized cleaning material, wherein coupling the first end of the adapter with the output port of the aerosol canister causes a valve of the adapter to engage a valve disposed in the output port of the adapter to allow aerosolized cleaning material to flow from the aerosol canister into the bore of the adapter;
coupling the second end of the adapter with a first end of a hose;
coupling a second end of the hose with an input port of the gun-style applicator; and
actuating a trigger of the gun-style applicator causing the aerosolized cleaning material to flow through the bore of the adapter, through the hose, through an internal portion of the gun-style applicator and out of a nozzle of the gun-style applicator.

20. The method of claim 19, wherein the canister of aerosolized cleaning material is configured to hold between about 12 ounces and 24 ounces of aerosolized cleaning material when full.
